(19) United States
(12) Patent Application Publication
(10) Pub. No.: US 2026/0357073 A1
(43) Pub. Date: Nov. 12, 2026

(54) PROCESS FOR PRODUCING HIGH-PURITY QUARTZ FROM IRON ORE TAILINGS OR WASTE, HIGH-PURITY QUARTZ, AND USE

(71) Applicants: Vale S.A., Rio de Janeiro (BR); SERVIÇO NACIONAL DE APRENDIZAGEM INDUSTRIAL, DEPARTAMENTO REGIONAL DA BAHIA – SENAI/DR/BA, Salvador (BR)

(72) Inventors: Henrique Júnio Oliveira LOPES, Itaperuna (BR); Caroline Melo RIBEIRO, Rio de Janeiro (BR); Joyce Silva DE PAULA, Contagem (BR); Paulo Henrique Marques MODESTO, Belo Horizonte (BR); Laís Resende PEREIRA, Belo Horizonte (BR); Neymayer Pereira LIMA, Ouro Preto (BR)

(21) Appl. No.: 19/131,894

(22) PCT Filed: Nov. 17, 2023
(86) PCT No.: PCT/BR2023/050399

§ 371 Date: May 21, 2025

(30) Foreign Application Priority Data
Nov. 21, 2022 (BR) 1020220235929

(51) Int. Cl. C09C 1/30; B03B 5/28; B03C 1/30; C09C 3/00

(52) U.S. Cl. CPC C09C 1/3009; B03B 5/28; B03C 1/30; C09C 3/003; B03C 2201/18; C01P 2004/02; C01P 2004/61; C01P 2006/80

(57) ABSTRACT

The present invention refers to a process for producing high-purity quartz from iron ore tailings or waste. More precisely, the present invention deals with obtaining quartz with purity above 99.00%, wherein the starting material is tailings consisting of about 89% to about 92% quartz and about 8% to about 11% impurities, or quartzite consisting of about 96% quartz and about 4% impurities. Furthermore, the present invention also pertains to the high-purity quartz product thus obtained, as well as to its use for applications requiring high-purity quartz, such as for the production of electronic-grade silicon and solar-grade silicon.

### FIELD OF INVENTION

This invention refers to a process for producing high-purity quartz from iron ore tailings or waste, especially for obtaining quartz with purity above 99.00%, which is suitable for applications requiring high-purity quartz such as for the production of electronic-grade silicon and solar-grade silicon.

### BACKGROUND OF THE INVENTION

Currently, in the mining industry, there are technological efforts aimed at using sandy tailings from the processing of iron ore to obtain products for civil construction. However, in this context, the products have low added value. In this scenario, the present invention envisions the maximization of the use of mineral resources through the reuse of the sandy tailings generated to obtain a product with high added value.

In view of this, the present invention starts by joining tailings from various stages of the beneficiation of iron ore from itabirite rock and faces the challenge of selectively increasing its purity in quartz by reducing residual hematite (Fe₂O₃), which comes from the original geological formation, as well as of the technological limitations of the beneficiation of iron ore (which is not efficient enough to concentrate all the iron).

Said itabirite rock has a composition of about 43% iron and about 36% quartz, and the final tailings have a particle size with a D90 of about 212 microns. Hematite presents a trigonal crystal system and red to brown and metallic gray to black color. In the sandy tailings, residual hematite is mostly found as inclusions in the quartz grains, which makes its separation challenging. In this context, the present invention proposes a route with physical and chemical processes based on the properties that differentiate quartz from hematite and on the concentration principle to obtain high-purity quartz.

The prior art encompasses documents that provide for obtaining higher-purity quartz from concentration routes products with lower SiO₂ contents, including tailings from iron ore beneficiation.

Patent document CN112194145 addresses the production of high-purity quartz powder from quartz sand or quartz veins with SiO₂ content that is greater than or equal to 90%, achieving quartz powder with SiO₂ content greater than or equal to 99.99%. Despite teaching the reuse of tailings generated throughout the proposed process, which are recycled and fed into an ore processing plant for maximum use of resources, this document does not use tailings or waste from mineral beneficiation as a starting material for the production of high-purity quartz. The process for obtaining high-purity quartz proposed by this document comprises grinding, magnetic separation, scrubbing, and flotation.

The master's dissertation entitled “Estudo da viabilidade técnica do aproveitamento do resíduo arenoso da mineração do itabirito” [Study of the technical feasibility of the use of sandy waste from itabirite mining] (Marcus Vinicius Campos Tolentino, 2010), in turn, refers to the use of sandy waste from itabirite mineral beneficiation to obtain a product with 99.997% silica content, in which the said tailings have a quartz content greater than 80% and a hematite content less than 20%. Furthermore, the said tailings have a fine particle size between 100 and 150 microns. This document mentions the importance of the degree of liberation of the sandy residue for its treatment, explaining that the degree of quartz liberation is better for the fraction between 53 and 44 microns of the tailings. This document discloses a process comprising magnetic separation and acid leaching, which enables the achievement of the said result in silica content through high acid contents in leaching as well as high time and temperature.

The scientific document entitled “Silica and iron recovery from a residue of iron ore flotation” (P.F.F. Martins et al., 2017) also refers to the recovery of silica and iron from tailings from the concentration of iron ore. For silica concentration, this document discloses a process comprising sorting, magnetic separation, and acid leaching. In the context of acid leaching, this document mentions difficulty in removing Fe contaminants after magnetic separation and uses drastic conditions such as acid mixtures (HF/HCl) and also acid digestion with H₂SO₄ at high temperature (200 °C) and, lastly, reaching a maximum content of 98% silica.

The doctoral thesis entitled “Obtenção de sílica de elevada pureza a partir do rejeito de flotação de um minério itabirítico” [Obtaining high-purity silica from the flotation tailings of an itabirite ore] (Polyana Fabrícia Fernandes Martins, 2016) reveals a route for obtaining high-purity silica that uses sludge from desliming and tailings from iron ore flotation as a starting material. The proposed route comprises steps of granulometric classification, magnetic separation, leaching (basic and acidic), and chemical precipitation, the latter comprising the acidification of the liquor from basic leaching. At the end of the process, amorphous silica is obtained, with a pozzolanic characteristic and purity of 99.9%.

As explained above, there are prior art efforts targeted at obtaining high-purity silica from mining tailings. However, there remains a need for a process route to obtain quartz for the production of electronic-grade silicon and solar-grade silicon that is cost-effective, in addition to issues pertaining to the environmental impact generated by the byproducts and energy consumed throughout the process. In this context, the present invention proposes a process that allows obtaining high-purity quartz, especially with a purity degree above 99.00%, from mineral beneficiation tailings through simple physical and chemical processes and taking into consideration the environmental impact generated.

Additionally, the present invention contributes to reducing the occupational disease known as silicosis that is caused by the operator's exposure to silica particles during the conventional quartz production process.

As will be better expanded upon below, the present invention aims to solve the problems of the prior art described above in a practical and efficient way.

### SUMMARY OF INVENTION

The present invention refers to a process for obtaining high-purity quartz from iron ore tailings or waste. Preferably, the present invention uses iron ore sandy tailings as the starting material, which is made up of about 89% to about 92% quartz and about 8% to about 11% impurities. The present invention may also use waste quartzite, which is made up of about 96% quartz and about 4% impurities.

The present invention aims to provide a processing route for the reuse of mining tailings or waste in the generation of a high-value-added product. In this context, the present invention also envisions the high-purity quartz product (>99.00%) thus obtained, as well as its use for the manufacture of semiconductor materials, electronic devices, solar panels, flat glass, containers, glass fibers, enamels, molds, artificial rocks, among others.

In addition, the present invention also envisions obtaining products on the path between starting quartz, suitable for civil construction, and quartz suitable for the production of electronic-grade and solar-grade silica. In this context, the present invention envisions the quartz product suitable for the production of metallurgical-grade silicon, as well as its use for the production of electronic-grade and solar-grade silicon, among others.

The objects referred to, and other advantages of the present invention, will be more evident from the description that follows.

### BRIEF DESCRIPTION OF FIGURES

FIG. 1 illustrates a simplified operational flowchart of a high-purity quartz production route embodiment of the present invention.

FIG. 2 illustrates a micrograph showing hematite inclusions in quartz.

FIG. 3 illustrates a graph with the results of chemical analyses showing the chemical composition of the granulometric ranges of the starting material of the process of the present invention.

FIG. 4a illustrates the sample of fraction 864-019 (−32 #/+65 #) prepared for liberation analysis, and FIG. 4b illustrates the sample of the same fraction analyzed for liberation.

FIG. 5a illustrates the sample of fraction 864-020 (−65 #/+150 #) prepared for liberation analysis, and FIG. 5b illustrates the sample of the same fraction analyzed for liberation.

FIG. 6a illustrates the sample of fraction 864-021 (−150 #/+200 #) prepared for liberation analysis, and FIG. 6b illustrates the sample of the same fraction analyzed for liberation.

FIG. 7a illustrates the sample of fraction 864-022 (−200 #/+400 #) prepared for liberation analysis, and FIG. 7b illustrates the sample of the same fraction analyzed for liberation.

FIG. 8 illustrates the modal mineralogy of the fractions analyzed by AMICS.

FIG. 9 graphically illustrates mineral liberation results by quartz particle composition.

FIG. 10 graphically illustrates mineral liberation results by quartz-free surface.

FIG. 11 graphically illustrates mineral liberation results by hematite particle composition.

FIG. 12 graphically illustrates mineral liberation results by quartz-free surface.

### DETAILED DESCRIPTION OF INVENTION

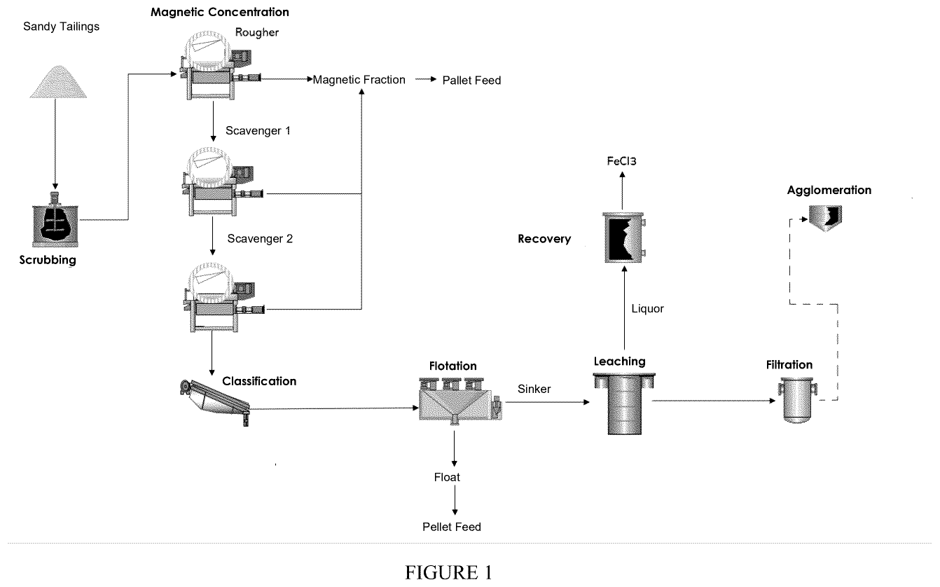

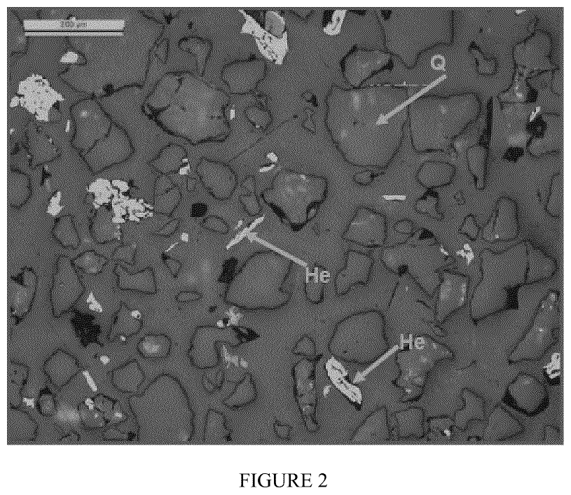

In order to achieve the above-described purposes, the present invention provides a process for producing high-purity quartz, in particular with purity above 99.00%, from iron ore tailings or waste. More precisely, an embodiment of the present invention provides a process comprising at least the steps of scrubbing, magnetic separation, leaching, and filtration. Optionally, said process further comprises a flotation step, whether or not preceded by a classification step. FIG. 1 illustrates a simplified flowchart of this process route of the present invention.

In a preferred embodiment of the present invention, the starting material consists of sandy tailings from itabirite iron ore beneficiation comprising between about 89% and about 92% SiO₂. The present invention may also use waste quartzite, which is made up of about 96% quartz.

The sandy tailings are conducted to the scrubbing step, which consists of a pre-concentration step of the quartz particles. According to the present invention, scrubbing is carried out in the presence of a dispersing agent and water in a stirrer tank, with rotation between about 500 rpm and about 1000 rpm and with a pH of the medium greater than about 9.5. Said dispersing agent is selected from the group consisting of NaOH, Na(PO₃)₆ (sodium hexametaphosphate), and sodium silicate. Preferably, the dispersing agent is NaOH. Optionally, scrubbing may be assisted by ultrasound.

Alternatively, according to the present invention, the scrubbing step is conducted by means of ultrasound and in the absence of a dispersing agent. More precisely, an alternative embodiment of the present invention provides a process comprising at least the steps of ultrasound, magnetic separation, leaching, and filtration. Optionally, said process further comprises a flotation step, whether or not preceded by a classification step.

According to the present invention, after the scrubbing or, alternatively, the ultrasound step, the material proceeds to the quartz concentration steps, which consist of magnetic separation, sorting, flotation, and leaching.

The magnetic separation step is conducted in a drum-type magnetic separator, magnetic roll, overhead pulley, cross belt, REDS (Rare Earth Magnetic Drums), WHIM (Wet High-Intensity Magnetic Separator), HGMS (High-Gradient Magnetic Separator), LIMS (Low-Intensity Magnetic Separator), IRM (Induced-Roll Magnetic Separator), or OGMS (Open-Gradient Magnetic Separator). In a preferred embodiment, the magnetic separation is conducted in a high-gradient magnetic separator, with pulp bed pulsing between about 100 rpm and about 300 rpm and magnetic field strength between about 5000 Gauss and about 15000 Gauss, with solids content ranging from about 25% to about 40%. Preferably, the magnetic separation comprises from 1 to 4 stages.

The quartz-rich, non-magnetic fraction from the magnetic separation is optionally conducted to the next mineral sorting step. According to the present invention, particles are classified between about −212 microns and about +106 microns. The magnetic fraction, in turn, can be recycled to the iron ore beneficiation process.

The non-magnetic fraction (classified or not) is further conducted for an optional flotation step aiming at the flotation of free hematite particles or with some degree of association with other minerals. According to the present invention, flotation is conducted using collectors selected from the group consisting of fatty acids with chain variations, sarcosinates, hydroxamates, sulfocinamates, sulfonates, oleates (oleic acid, sodium oleate, and the like), among others. The depressants are selected from sodium silicates having a pH between about 4 and about 9. The collector and depressant dosages range from about 100 to about 1000 g/t, and the percentage of solids in the pulp ranges from about 30% to about 50%.

In order to achieve a material with more than 99% SiO₂, the depressed material of the flotation step or the product from the previous magnetic separation step (in the case of absence of the flotation step) is conducted to the last mineral concentration step, consisting of acid leaching. This step is conducted on a stir plate with heating. In this regard, the leaching reagent is selected from the group consisting of HCl, HF, H₂SO₄, HNO₃, or mixtures thereof, and in concentration between about 3 mol/L and about 10 mol/L. Preferably, the leaching reagent is HCl. In a preferred embodiment, the leaching is conducted at a temperature between about 50 °C and about 100 °C and for about 15 minutes and about 120 minutes. The acidic liquor from leaching can be reused for the production of ferric chloride, which can be used for water treatment.

Lastly, the concentrated product obtained is filtered using a vacuum filter, disc filter, filter press, or similar process.

It should be noted that, in order to meet the requirements of the envisioned market, the product obtained by the process proposed herein can be additionally subjected to an agglomeration process.

In view of the foregoing, the present invention proposes a new concentration route for obtaining high-purity quartz from iron ore tailings and of suitable quality for application in the production of electronic-grade silicon and solar-grade silicon. In addition, it is important to point out that the present invention allows obtaining high value-added products by means of simple physical and chemical methods and without the use of drastic operating conditions, such as high acid contents and high temperatures. Therefore, it is evident that the present invention constitutes an environmentally friendly, as well as economical, solution for the production of high-purity quartz.

The description that has been made so far of the object of the present invention should be considered only as possible embodiment, and any particular characteristics introduced therein should be understood only as something that has been written to facilitate understanding. Thus, they should not be considered as limiting the invention, which is limited to the scope of the claims.

The examples that will be presented illustrate the ranges of the products generated through the process proposed herein.

### EXAMPLES

### Example 1—Mineralogical Composition of Starting Material

The mineralogical composition of iron ore tailings used in the present invention was characterized by means of X-ray diffractometry. In this context, around 90.7% of quartz and 6.3% of hematite were found present in the sample. The characterization of the sample is illustrated in Table 1.

TABLE 1
Calculated Mineralogical and
Chemical Composition.

| wRp | Chi2 | Qtz | Hem | Gt |
|---|---|---|---|---|
| 17.9 | 8.8 | 90.7 | 6.4 | 2.9 |
| | SiO2 | Fe | H2O | |
| | 90.7 | 6.3 | 0.3 | |

### Example 2—Particle Size Distribution of Starting Material

Ten granulometric ranges were analyzed using three complementary methodologies, as follows:
wet sieving using nine sieves and allowing the determination of 10 granulometric ranges;
the sample <400 #was analyzed by a laser granulometer; and
the sample <400 #was subjected to a cyclosizer assay to segregate the sample into calculated particle size fractions, and, from these fractions, subsequent granulochemical analysis could be performed.

Table 2 illustrates the particle size distribution by ranges.

TABLE 2
Particle Size Distribution by Ranges.

| | Aperture | Mass | Retained | Cumulative |
|---|---|---|---|---|
| Fraction | (mm) | (g) | Percentage | Passing Percentage |
| Particle size fraction +16# | 1000 | 245.30 | 1.24 | 98.75 |
| Particle size fraction −16#/+32# | 500 | 623.30 | 3.16 | 95.59 |
| Particle size fraction −32#/+48# | 300 | 544.00 | 2.76 | 92.82 |
| Particle size fraction −48#/+65# | 212 | 2345.70 | 11.92 | 80.90 |
| Particle size fraction −65#/+100# | 150 | 3752.60 | 19.07 | 61.83 |
| Particle size fraction −100#/+150# | 106 | 4615.80 | 23.45 | 38.37 |
| Particle size fraction −150#/+200# | 75 | 2616.90 | 13.30 | 25.07 |
| Particle size fraction −200#/+325# | 45 | 2139.10 | 10.87 | 14.20 |
| Particle size fraction −325#/+400# | 38 | 473.00 | 2.40 | 11.79 |
| Particle size fraction −400# | −38 | 2320.00 | 11.79 | 0.00 |

### Example 3—Granulochemical Analysis of Particle Size Fractions of Starting Material

The particle size fractions obtained were subjected to chemical analyses by different methods. The techniques used were:
majority oxides by the X-ray fluorescence by wavelength method;
LOI (Loss on Ignition); and
infrared carbon and sulfur determination-LECO.

From the analyses, it was possible to observe that most of the iron oxides (mostly hematite) are present in the thicker and finer fractions of the tailings, and the intermediate fractions (which are more representative by mass) have mostly an amount above 90% of silica.

| Sample | | SiO2 | Al2O3 | Fe2O3 | CaO | MgO | TiO2 | P2O5 | Na2O | K2O | MnO |
|---|---|---|---|---|---|---|---|---|---|---|---|
| 864-001 | Head Sample | 89.2 | 0.17 | 10.8 | 0.02 | <0.1 | 0.01 | 0.02 | <0.1 | <0.01 | 0.08 |
| 864-003 | Particle size fraction +16# | 37.1 | 0.84 | 57.7 | 0.02 | <0.1 | 0.05 | 0.18 | <0.1 | 0.03 | 1.04 |
| 864-004 | Particle size fraction −16#/+32# | 59.6 | 0.63 | 37.9 | 0.02 | <0.1 | 0.03 | 0.12 | <0.1 | 0.02 | 0.8 |
| 864-005 | Particle size fraction +32#/+42# | 83.5 | 0.31 | 16.2 | 0.02 | <0.1 | 0.01 | 0.05 | <0.1 | <0.01 | 0.28 |
| 864-006 | Particle size fraction −42#/+65# | 93.9 | <0.1 | 6.53 | 0.03 | <0.1 | <0.01 | <0.01 | <0.1 | <0.01 | 0.07 |
| 864-007 | Particle size fraction −65#/−100# | 97.1 | <0.1 | 3.72 | 0.03 | <0.1 | <0.01 | <0.01 | <0.1 | <0.01 | <0.01 |
| 864-008 | Particle size fraction −100#/+150# | 97.4 | <0.1 | 3.97 | 0.02 | <0.1 | <0.01 | <0.01 | <0.1 | <0.01 | <0.01 |
| 864-009 | Particle size fraction −150#/+200# | 94.7 | 0.37 | 6.05 | 0.04 | <0.1 | <0.01 | <0.01 | <0.1 | <0.01 | <0.01 |
| 864-010 | Particle size fraction −200#/+350# | 88.6 | 0.19 | 11.3 | 0.03 | <0.1 | <0.01 | 0.01 | <0.1 | <0.01 | 0.01 |
| 864-011 | Particle size fraction −350#/+400 | 84.5 | 0.27 | 16.2 | 0.03 | <0.1 | 0.02 | 0.01 | <0.1 | 0.01 | 0.02 |
| 864-012 | Particle size fraction −400 | 67.9 | 0.71 | 31.4 | 0.03 | <0.1 | 0.06 | 0.03 | <0.1 | 0.02 | 0.1 |
| 864-013 | Cyclosizer C1 Particle Size Fraction | 88.3 | <0.1 | 12 | 0.03 | <0.1 | <0.01 | <0.01 | <0.1 | <0.01 | 0.01 |
| 864-014 | Cyclosizer C2 Particle Size Fraction | 53.6 | 0.31 | 43.8 | 0.03 | <0.1 | 0.07 | 0.02 | <0.1 | <0.01 | 0.07 |
| 864-015 | Cyclosizer C3 Particle Size Fraction | 49.6 | 1.18 | 46.6 | 0.05 | <0.1 | 0.12 | 0.05 | 0.13 | 0.03 | 0.19 |
| 864-016 | Cyclosizer C4 Particle Size Fraction | 50.2 | 2.36 | 42.6 | 0.05 | 0.11 | 0.14 | 0.09 | 0.17 | 0.08 | 0.3 |
| 864-017 | Cyclosizer C5 Particle Size Fraction | 53.4 | 4.04 | 31.1 | 0.1 | 0.15 | 0.15 | 0.11 | 0.12 | 0.19 | 0.36 |

| Sample | | BaO | Co | Cu | Cr2O3 | Nb2O5 | V2O5 | NiO | LOI |
|---|---|---|---|---|---|---|---|---|---|
| 864-001 | Head Sample | <0.01 | 0.01 | <0.01 | 0.02 | <0.05 | <0.01 | <0.01 | 0.1 |
| 864-003 | Particle size fraction +16# | 0.06 | 0.008 | <0.01 | <0.01 | <0.05 | 0.01 | <0.01 | 3.07 |
| 864-004 | Particle size fraction −16#/+32# | 0.04 | 0.005 | <0.01 | <0.01 | <0.05 | <0.01 | <0.01 | 2.09 |
| 864-005 | Particle size fraction +32#/+42# | <0.01 | <0.005 | <0.01 | <0.01 | <0.05 | <0.01 | <0.01 | 0.79 |
| 864-006 | Particle size fraction −42#/+65# | <0.01 | <0.005 | <0.01 | <0.01 | <0.05 | <0.01 | <0.01 | 0.18 |
| 864-007 | Particle size fraction −65#/−100# | <0.01 | <0.005 | <0.01 | <0.01 | <0.05 | <0.01 | <0.01 | 0.15 |
| 864-008 | Particle size fraction −100#/+150# | <0.01 | <0.005 | <0.01 | <0.01 | <0.05 | <0.01 | <0.01 | 0.06 |
| 864-009 | Particle size fraction −150#/+200# | <0.01 | <0.005 | <0.01 | <0.01 | <0.05 | <0.01 | <0.01 | 0.1 |
| 864-010 | Particle size fraction −200#/+350# | <0.01 | <0.005 | 0.01 | <0.01 | <0.05 | <0.01 | <0.01 | 0.26 |
| 864-011 | Particle size fraction −350#/+400 | <0.01 | <0.005 | 0.03 | <0.01 | <0.05 | <0.01 | <0.01 | 0.16 |
| 864-012 | Particle size fraction −400 | <0.01 | 0.006 | 0.51 | 0.01 | <0.05 | <0.01 | <0.01 | 0.74 |
| 864-013 | Cyclosizer C1 Particle Size Fraction | <0.01 | <0.005 | 0.03 | <0.01 | <0.05 | <0.01 | <0.01 | −0.03 |
| 864-014 | Cyclosizer C2 Particle Size Fraction | 0.01 | 0.006 | 0.21 | 0.01 | <0.05 | <0.01 | <0.01 | 0.34 |
| 864-015 | Cyclosizer C3 Particle Size Fraction | 0.02 | 0.005 | 0.77 | 0.01 | <0.05 | <0.01 | <0.01 | 1.1 |
| 864-016 | Cyclosizer C4 Particle Size Fraction | 0.02 | 0.005 | >1 | 0.02 | <0.05 | <0.01 | <0.01 | 2.11 |
| 864-017 | Cyclosizer C5 Particle Size Fraction | 0.04 | 0.007 | >1 | 0.04 | <0.05 | <0.01 | <0.01 | 1.1 |

Table 3 illustrates the granulochemical results of the sandy tailings.

### Table 3: Granulochemical Results of Sandy Tailings.

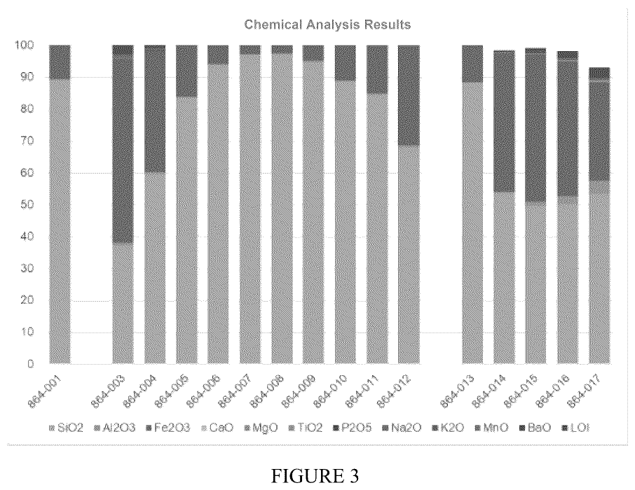

In FIG. 3, it is possible to observe graphically the chemical composition of the granulometric ranges in question.

### Example 4—Analysis of Morphology, Grain Arrangement, and Chemical Composition of Tailings Grains

Analysis of the morphology and arrangement of the grains were conducted visually using Scanning Electron Microscopy (SEM) with an X-ray Energy Dispersive Detector (EDD) and automated mineral liberation system (ALM) coupled, using the AMICS software to determine phases by the interaction of electrons with the sample.

Four granulometric fractions of the sandy tailings, representative by mass, were chosen to conduct the liberation analysis:
sample 864-019 (−32 #/+65 #);
sample 864-020 (−65 #/+150 #);
sample 864-021 (−150 #/+200 #); and
sample 864-022 (−200 #/+400 #).

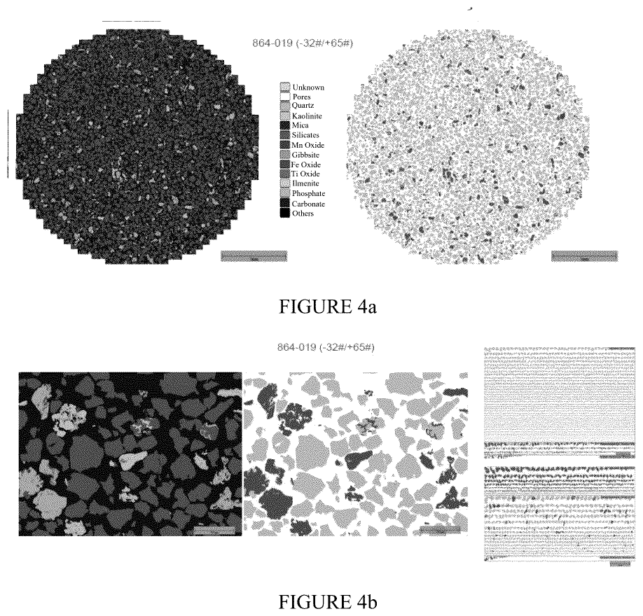

The first fraction (sample 864-019) showed a relatively high amount of free and occluded hematite grains in the sample, and with grain size similar to those of quartz grains. FIG. 4a shows an image of sample 864-019 prepared for analysis, where qualitatively identifying the arrangement and intensity of free and mixed minerals is possible. FIG. 4b shows an image of sample 864-019 analyzed for liberation.

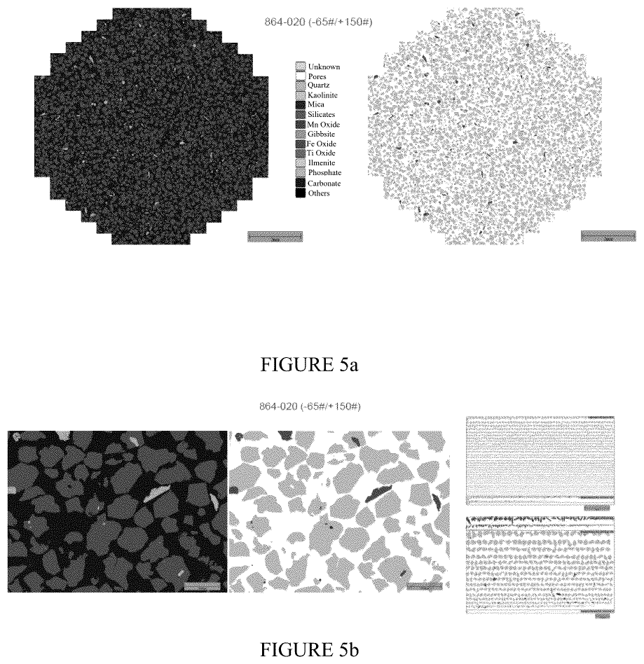

The second fraction (sample 864-020) showed a relatively low amount of free and occluded hematite grains in the sample, and with grain size similar to those of quartz grains. FIG. 5a shows an image of sample 864-020 prepared for analysis, where qualitatively identifying the arrangement and intensity of free and mixed minerals is possible. FIG. 5b shows an image of sample 864-020 analyzed for liberation.

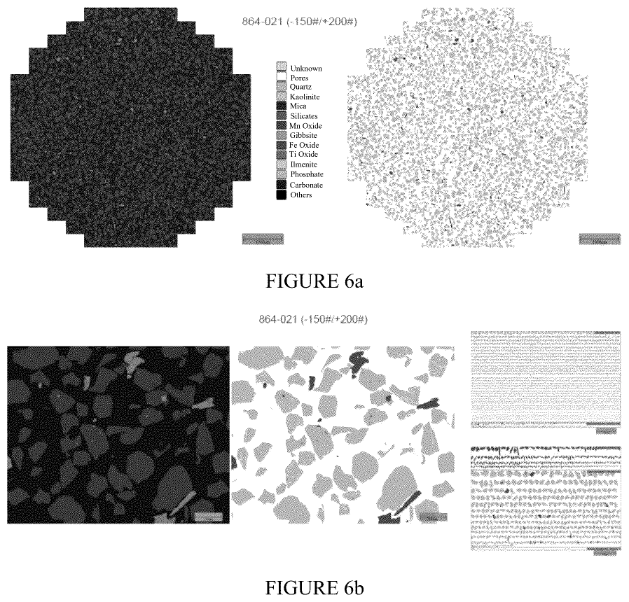

The third fraction (sample 864-021) also showed a relatively low amount of free and occluded hematite grains in the sample, with smaller grain size than quartz grains. FIG. 6a shows an image of sample 864-021 prepared for analysis, where qualitatively identifying the arrangement and intensity of free and mixed minerals is possible. FIG. 6b shows an image of sample 864-021 analyzed for liberation.

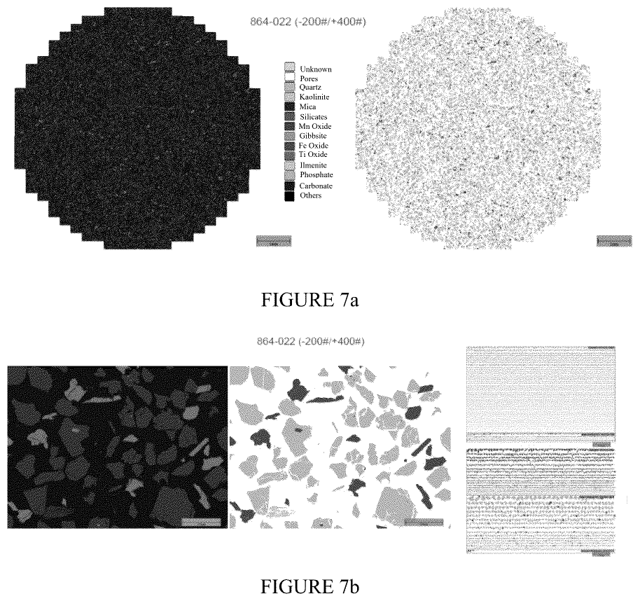

The fourth fraction (sample 864-022) showed a relatively high amount of free and occcluded hematite grains in the sample, with smaller grain size than quartz grains, similar to the characteristics of the first sample in terms of hematite grain volume. FIG. 7a shows an image of sample 864-022 prepared for analysis, where qualitatively identifying the arrangement and intensity of free and mixed minerals is possible. FIG. 7b shows an image of sample 864-022 analyzed for liberation.

### Example 5-Quantitative Analysis of Modal Mineralogy

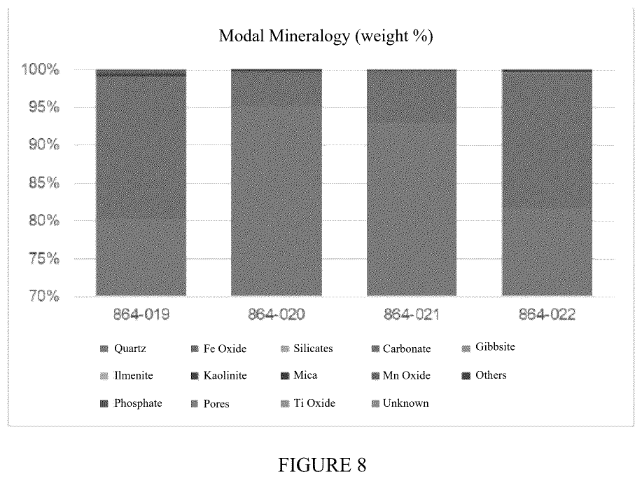

The same four particle size fractions of Example 4 were analyzed. Mineral segregation of the fractions was observed, so that the fractions with the most hematite were fractions 864-019 and 864-022 and the fractions with the lowest hematite contents were fractions 864-020 and 864-021. FIG. 8 graphically illustrates the modal mineralogy of each fraction quantitatively, analyzed by AMICS. Furthermore, the quantitative results generated were consistent with the qualitative analysis of the images according to Example 4.

### Example 6—Analysis of Degree of Liberation

From the evaluation of the automated images, the degree of mineral liberation was quantified by particle composition and by free surface of quartz and hematite in the four particle size fractions evaluated. It is important to mention that liberation by particle composition consists of the percentage of the area of a grain of an specific mineral within a particle, that is, how much of the specific mineral there is in a particle with different associated minerals. Free surface liberation, in turn, represents the exposed area that the grain of a specific mineral has in a particle.

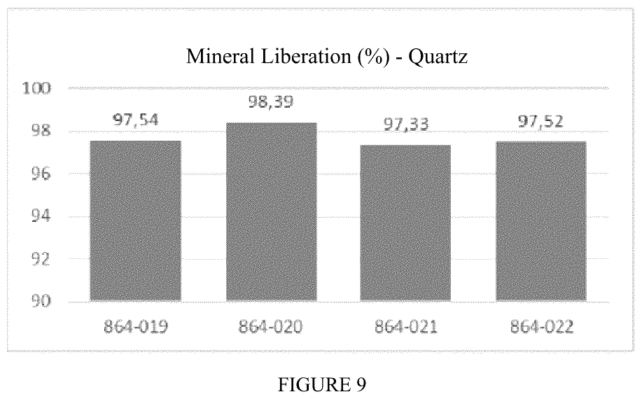

Regarding the degree of liberation of quartz grains by particle composition, it was observed that all fractions have a liberation greater than 97%, and fraction 864-020 reached a value of 98.39% mineral liberation. This result is shown in FIG. 9.

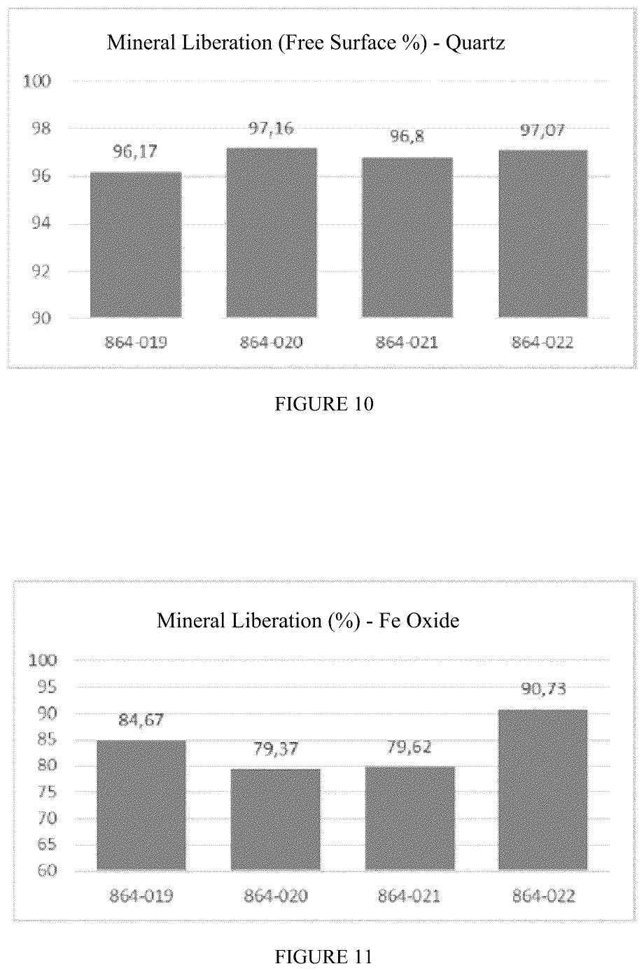

Regarding the degree of liberation of quartz grains by surface, it was observed that all fractions have liberation around 96%, and fraction 864-020 reached a value of 97.16% mineral liberation. This result is shown in FIG. 10.

Regarding the degree of liberation of hematite grains by particle composition, it was observed that all fractions have a varied liberation, in which the intermediate fractions have a lower liberation than the others (with less than 80% liberation). This result is shown in FIG. 11.

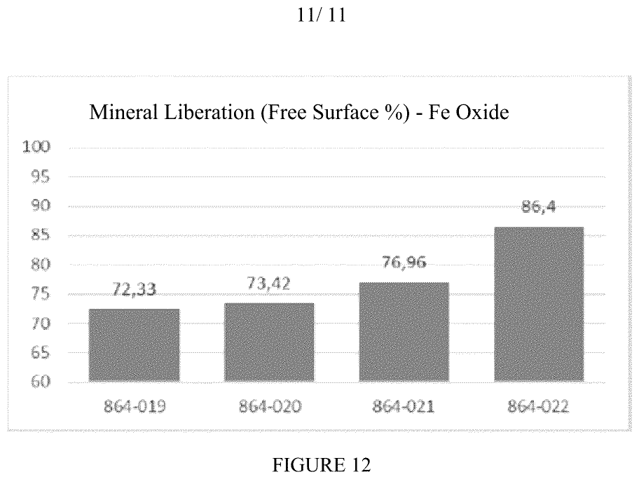

Regarding the degree of liberation of hematite grains by a free surface, results were slightly different from the previous one, in which all fractions have a varied liberation, in which the first three fractions presented less than 77% liberation. This result is shown in FIG. 12.

### Example 7—Acid Leaching

Regarding acid leaching, consisting of the last mineral concentration step of the process route proposed in the present invention, tests were conducted to evaluate the response of sandy tailings to acid leaching with HCl at concentrations between 5 and 7 mol/L. Leaching time was between 30 and 90 minutes, with temperatures between 60 and 80 °C. The tests were performed on a bench scale, with solids content of 20%.

A grade of 99.00% of SiO₂ was obtained for the sample subjected to a magnetic separation step (one stage in Slon separator) and leaching with 5 mol/L HCl for 90 min at 80 °C. Table 4 explains the results of the chemical analysis of this sample, conducted by means of X-ray fluorescence.

TABLE 4
Chemical Characterization of Tailings Sample after Magnetic Separation and Leaching.

| Fe₂O₃ | SiO₂ | P₂O₅ | Al₂O₅ | MnO | TiO₂ | CaO | MgO | Na₂O | K₂O | LOI |
|---|---|---|---|---|---|---|---|---|---|---|
| 1.28% | 99.00% | <0.01% | 0.12% | <0.01% | <0.01% | 0.030% | <0.1% | <0.01% | <0.01% | 0.09% |

The invention claimed is:

1. A process for producing high-purity quartz from iron ore tailings or waste, comprising the steps of:
scrubbing, carried out in an agitator tank with a speed between around 500 rpm and around 1000 rpm, in the presence of a dispersing agent selected from the group consisting of NaOH, Na(PO₃)₆ (sodium hexametaphosphate) and sodium silicate;
magnetic separation, carried out with a magnetic field strength between about 5000 Gauss and about 15000 Gauss, with solids content ranging from about 25% to about 40% and number of stages ranging from 1 to 4 stages; and
acid leaching, carried out in the presence of a leaching reagent selected from the group consisting of HCl, HF, H₂SO₄, HNO₃ or mixtures thereof, at a concentration between about 3 mol/L and about 10 mol/L, on a stirring plate with heating at a temperature between about 50 °C and about 100 °C and for about 15 minutes and about 120 minutes,
wherein said iron ore tailings comprise between about 89% and about 92% SiO₂, and said iron ore waste comprises about 96% SiO₂.

2. The process of claim 1, wherein the scrubbing step is conducted at pH greater than about 9.5.

3. The process of claim 1, wherein the dispersing agent is NaOH.

4. The process of claim 1, wherein the scrubbing step is optionally assisted by ultrasound.

5. The process of claim 1, wherein it optionally comprises a step of flotation of the non-magnetic particles from the magnetic separation step, said flotation step being optionally further preceded by a mineral classification step.

6. The process of claim 5, wherein, in the optional mineral sorting step, the non-magnetic particles from the previous magnetic separation step are sorted between about-212 microns to about +106 microns.

7. The process of claim 5, wherein flotation of the non-magnetic particles from the magnetic separation step, classified or not, is conducted in the presence of collectors selected from the group consisting of fatty acids with chain variations, sarcosinates, hydroxamates, sulfocinamates, sulfonates, and oleates (oleic acid, sodium oleate, and the like), and depressants selected from sodium silicates having pH between about 4 and about 9.

8. The process of claim 7, wherein the collector and depressant dosages in the flotation range from about 100 to about 1000 g/t and the percentage of solids in the pulp ranges from about 30% to about 50%.

9. The process of claim 1, wherein the leaching reagent is HCl.

10. The process of claim 1, wherein a step of filtering the solid phase from leaching using a vacuum filter, disc filter, and/or filter press is further comprised.

11. A process for producing high-purity quartz from iron ore tailings or waste, comprising the steps of:
ultrasound;
magnetic separation, carried out with a magnetic field strength between about 5000 Gauss and about 15000 Gauss, with solids content ranging from about 25% to about 40% and number of stages ranging from 1 to 4 stages; and
acid leaching, carried out in the presence of a leaching reagent selected from the group consisting of HCl, HF, H₂SO₄, HNO₃ or mixtures thereof, at a concentration between about 3 mol/L and about 10 mol/L, on a stirring plate with heating at a temperature between about 50 °C and about 100 °C and for about 15 minutes and about 120 minutes,
wherein said iron ore tailings comprise between about 89% and about 92% SiO2, and said iron ore waste comprises about 96% SiO2.

12. The process of claim 11, wherein it optionally comprises a step of flotation of the non-magnetic particles from the magnetic separation step, said flotation step being optionally further preceded by a mineral classification step.

13. The process of claim 11, wherein, in the optional mineral sorting step, the non-magnetic particles from the previous magnetic separation step are sorted between about −212 microns to about +106 microns.

14. The process of claim 12, wherein flotation of the non-magnetic particles from the magnetic separation step, classified or not, is conducted in the presence of collectors selected from the group consisting of fatty acids with chain variations, sarcosinates, hydroxamates, sulfocinamates, sulfonates, and oleates (oleic acid, sodium oleate, and the like), and depressants selected from sodium silicates having pH between about 4 and about 9.

15. The process of claim 14, wherein the collector and depressant dosages in the flotation range from about 100 to about 1000 g/t and the percentage of solids in the pulp ranges from about 30% to about 50%.

16. The process of claim 11, wherein the leaching reagent is HCl.

17. The process of claim 11, wherein it further comprises a step of filtering the solid phase from leaching using a vacuum filter, disc filter, and/or filter press.

18. A high-purity quartz provided by the process of 1 and having purity above 99.00%.

19. An electronic-grade and solar-grade silicon comprising the high-purity quartz of claim 18.

20. A semiconductor, solar panel, optical fiber, bioactive glass, or laboratory glassware comprising the electronic-grade and solar-grade silicon of claim 19.

21-27. (canceled)
